(19) United States
(12) Patent Application Publication
(10) Pub. No.: US 2025/0323599 A1
(43) Pub. Date: Oct. 16, 2025

(54) CLEANING SYSTEM FOR OUTDOOR EQUIPMENT

(71) Applicant: Earthgen Technology Co., Ltd., Tainan City (TW)

(72) Inventors: Heng-Teng CHEN, Tainan City (TW); Wen-Ta CHEN, Tainan City (TW); Wei-Hang CHEN, New Taipei City (TW); Qing-Yu CHEN, Taichung City (TW)

(21) Appl. No.: 19/173,990

(22) Filed: Apr. 9, 2025

(30) Foreign Application Priority Data
Apr. 10, 2024 (TW) 113203503

(51) Int. Cl. H02S 40/10; B08B 3/02; B08B 13/00; B64D 1/18; G05D 1/242; G05D 1/243; G05D 1/245; G05D 1/248; G05D 1/689; G05D 105/10; G05D 109/20; G06T 7/70; H02S 20/30

(52) U.S. Cl. CPC H02S 40/10; B08B 3/024; B08B 13/00; B64D 1/18; G05D 1/242; G05D 1/243; G05D 1/245; G05D 1/248; G05D 1/689; G06T 7/70; H02S 20/30; B08B 2203/02; G05D 2105/10; G05D 2109/20; G06T 2207/10032

(57) ABSTRACT

A cleaning system for an outdoor equipment includes a control console operable to output an operation instruction, an inertial measurement unit, and an unmanned aerial vehicle movable according to the operation instruction upon receipt of the same. The unmanned aerial vehicle includes an operational processor, a machine body, a cleaning module adapted for spraying a cleaning liquid, a route detection module configured to detect a position of the machine body relative to first and second support frames of the outdoor equipment and generate flight path information for assisting in movement of the machine body along a movement route, and an inertial measurement unit configured to detect a posture parameter set of the machine body related to a posture of the machine body and to output the posture parameter set to the operational processor.

### CROSS-REFERENCE TO RELATED APPLICATION

This application claims priority to Taiwanese Utility Model Patent Application No. 113203503, filed on Apr. 10, 2024, the entire disclosure of which is incorporated by reference herein.

### FIELD

The disclosure relates to a cleansing system, and more particularly to a cleaning system for cleaning an outdoor equipment.

### BACKGROUND

Currently, a solar power generation equipment is a renewable energy generation equipment which is usually built at a location with plenty of sunshine, and which receives solar energy through solar panels thereof and which converts the same into electricity to be supplied to a back-end power facility or stored for subsequent use. Generally, the efficiency of the solar power generation equipment is directly affected by whether the solar panels are able to fully receive the solar energy. However, since solar panels are usually mounted in open air for receiving sunlight, it is inevitable that the solar panels will become dirty due to wind, rain, or outdoor dust. Thus, efficiency of solar energy reception is adversely affected, which causes the solar power generation equipment to fail to generate electricity as expected.

In view of the abovementioned problems, the solar panels of the solar power generation equipment are regularly cleaned to reduce accumulated dirt thereon, thereby ensuring the power generation efficiency of the solar power generation equipment. However, since the solar panels of a solar power generation system usually occupy a relatively wide area, cleaning the solar panels is labor-intensive.

### SUMMARY

Therefore, an object of the present disclosure is to provide a cleaning system for an outdoor equipment that can alleviate at least one of the drawbacks of the prior art.

According to an aspect of the disclosure, a cleaning system for an outdoor equipment is provided. The outdoor equipment includes a plurality of first support frames that are spaced apart from each other in a first direction, a plurality of second support frames that are spaced apart from each other in a second direction transverse to the first direction and that intersect the first support frames to form a matrix, and a plurality of panels that are mounted on the first support frames and the second support frames. The cleaning system for the outdoor equipment includes a control console, at least one unmanned aerial vehicle, and an inertial measurement unit. The control console is operable to output at least one operation instruction. The at least one unmanned aerial vehicle is communicatively connected to the control console, is movable according to the at least one operation instruction upon receipt of the at least one operation instruction, and includes an operational processor, a machine body, a cleaning module, and a route detection module. The operational processor is configured to receive and process the at least one operation instruction to generate movement information. The machine body is connected to the operational processor, and is communicatively connected to the operational processor for receiving the movement information, and is moved according to the movement information. The cleaning module is mounted to the machine body and is adapted for spraying a cleaning liquid to clean the panels. The route detection module is communicatively connected to the operational processor, and is configured to detect a position of the machine body relative to the first support frames and the second support frames of the outdoor equipment to generate flight path information that is for assisting in movement of the machine body along a movement route. The inertial measurement unit is mounted to a center of gravity of the machine body of the unmanned aerial vehicle, is communicatively connected to the operational processor, is configured to detect a posture parameter set of the machine body related to a posture of the machine body and to output the posture parameter set to the operational processor.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view of an embodiment of a cleaning system according to the present disclosure and a solar power equipment.

FIG. 2 is a front view of an unmanned aerial vehicle of the embodiment of the cleaning system.

FIG. 3 is a block diagram illustrating an operational processor, a route detection module and a storage module of the embodiment.

FIG. 4 is a perspective view of a cleaning bracket of a cleaning module of the unmanned aerial vehicle of the embodiment.

FIG. 5 is a flow chart, illustrating a cleaning process of the embodiment.

FIG. 6 is a schematic front view illustrating a rotatable member of the cleaning bracket being parallel to a solar panel of the solar power equipment to be cleaned.

FIG. 7 is a fragmentary side view of the cleaning bracket, illustrating a rotary tube of the cleaning bracket being rotatable.

FIG. 8 is a fragmentary side view of the cleaning bracket, illustrating the cleaning bracket being rotated toward a direction from which wind is blowing.

FIG. 9 is a schematic view illustrating a rotatable member of the cleaning bracket being rotatable.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

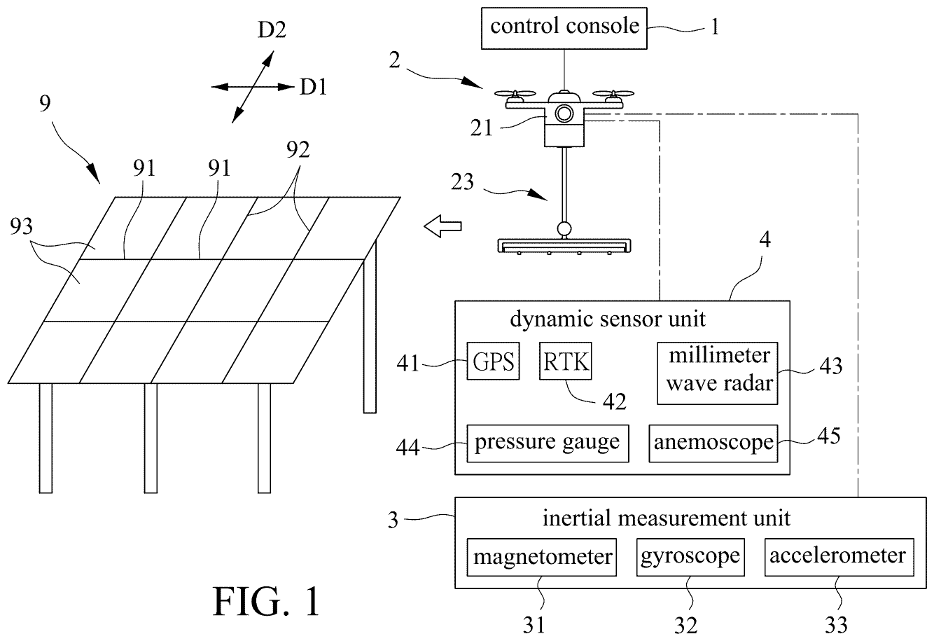

Referring to FIG. 1, an embodiment of a cleaning system according to the present disclosure is for cleaning an outdoor equipment 9. In this embodiment, the outdoor equipment 9 is exemplified as a solar power equipment and includes a plurality of first support frames 91 spaced apart from each other in a first direction (D1), a plurality of second support frames 92 spaced apart from each other in a second direction (D2) transverse to the first direction (D1) and intersecting the first support frames 91 to form a matrix, and a plurality of panels 93 mounted on the first support frames 91 and the second support frames 92. In this embodiment, the panels 93 are solar panels, and the panels 93 are referred to as solar panels 93 in the following description. The cleaning system includes a control console 1 that is operable to output at least one operation instruction, an unmanned aerial vehicle 2 that is communicatively connected to the control console 1 and that is movable according to the at least one operation instruction upon receipt of the at least one operation instruction, an inertial measurement unit 3 that is mounted to the unmanned aerial vehicle 2, and a dynamic sensor unit 4 that is mounted to the unmanned aerial vehicle 2.

Specifically, for example, the control console 1 is disposed in a field for building the solar power equipment that is to be cleaned by the cleaning system, and is operated by a staff member to clean the solar power equipment that is disposed in the staff member's line of sight. In one embodiment, relevant data such as a location of the solar power equipment and a range covered by the solar power equipment is stored in the unmanned aerial vehicle 2 in advance, such that the unmanned aerial vehicle 2 is able to perform a cleaning operation upon receipt of the at least one operation instruction, e.g., a departure instruction, from the control console 1. In addition, in a case where the solar panels 93 of the solar power equipment occupy a relatively large area, the control console 1 may output a plurality of operation instructions, where each of the operation instructions is dedicated for cleaning some of the solar panels 93 that are disposed within a designated area.

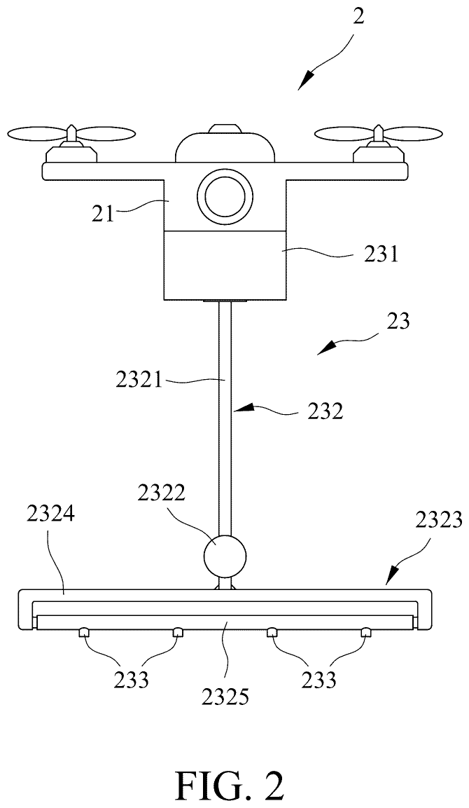

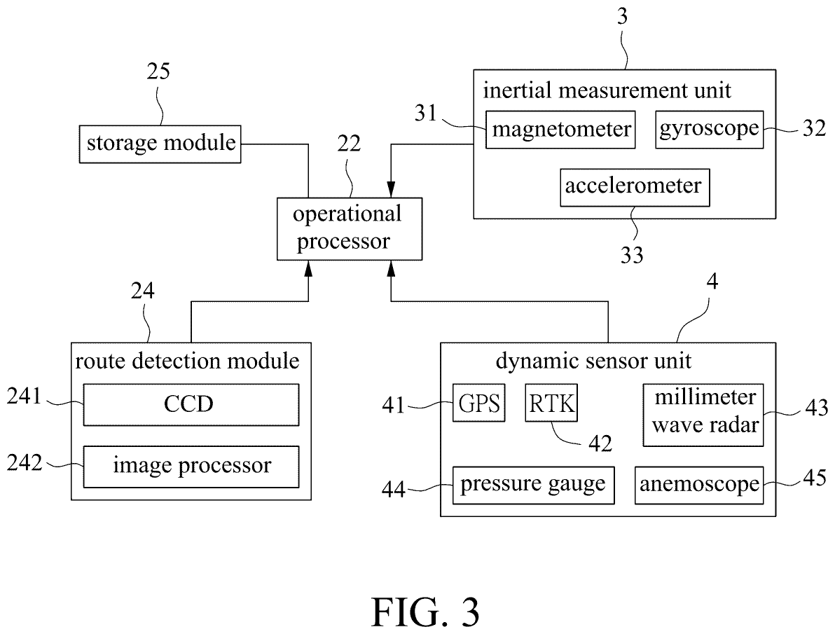

Referring to FIGS. 2 and 3, the unmanned aerial vehicle 2 includes an operational processor 22 configured to receive and process the at least one operation instruction to generate movement information, a machine body 21 connected to the operational processor 22 and communicatively connected to the operational processor 22 for receiving the movement information and being moved according to the movement information, a cleaning module 23 mounted to the machine body 21 and adapted for spraying a cleaning liquid to clean the solar panels 93, a route detection module 24 communicatively connected to the operational processor 22 and configured to detect a position of the machine body 21 relative to the first support frames 91 and the second support frames 92 to generate flight path information that is for assisting in movement of the machine body 21 along a movement route, and a storage module 25 communicatively connected to the operational processor 22 and configured to store the relevant data and to record the operation instruction(s) received by the unmanned aerial vehicle 2, the movement route and the flight path information of the unmanned aerial vehicle 2 each time the unmanned aerial vehicle 2 performs the cleaning operation, i.e., cleaning the solar power equipment. It should be noted that, in order to ensure the stability of flight of the unmanned aerial vehicle 2, and considering the popularity of existing models of unmanned aerial vehicles on the market, the unmanned aerial vehicle 2 is a multi-rotor model in this embodiment, but the present disclosure is not limited to this example.

The route detection module 24 includes an image capture device 241 configured to capture a to-be-analyzed image around the machine body 21 for detecting a position of the machine body 21 relative to the first support frames 91 and the second support frames 92 when the unmanned aerial vehicle 2 is flying, and an image processor 242 communicatively connected to the image capture device 241 and configured to generate, based on the to-be-analyzed image, the flight path information that is indicative of directions in which the unmanned aerial vehicle 2 is to be controlled to fly and that is for assisting in the movement of the unmanned aerial vehicle 2 along the movement route. Specifically, the flight path information is provided to ensure that the unmanned aerial vehicle 2 is flying in either one of the first direction (D1) in which the first support frames 91 are arranged or the second direction (D2) in which the second support frames 92 are arranged. That is to say, the flight path information enables the unmanned aerial vehicle 2 to fly parallel to the first support frames 91 and the second support frames 92. In one embodiment, upon receipt of a departure instruction, the unmanned aerial vehicle 2 flies toward the solar power equipment, e.g., to a periphery of the solar panels 93 for washing the same, the image capture device 241 of the route detection module 24 captures the to-be-analyzed image around the machine body 21 in real time that is indicative of a position of the machine body 21 relative to the first support frames 91 and the second support frames 92, and then the image processor 242 generates the flight path information accordingly to control the unmanned aerial vehicle 2 to fly along the first support frames 91 or the second support frames 92, thereby assisting in movement of the machine body 21 along the movement route. Thus, the unmanned aerial vehicle 2 may fly in a relatively stable manner during cleaning. In one embodiment, the image capture device 241 may include a camera, e.g., a charge coupled device (CCD) camera.

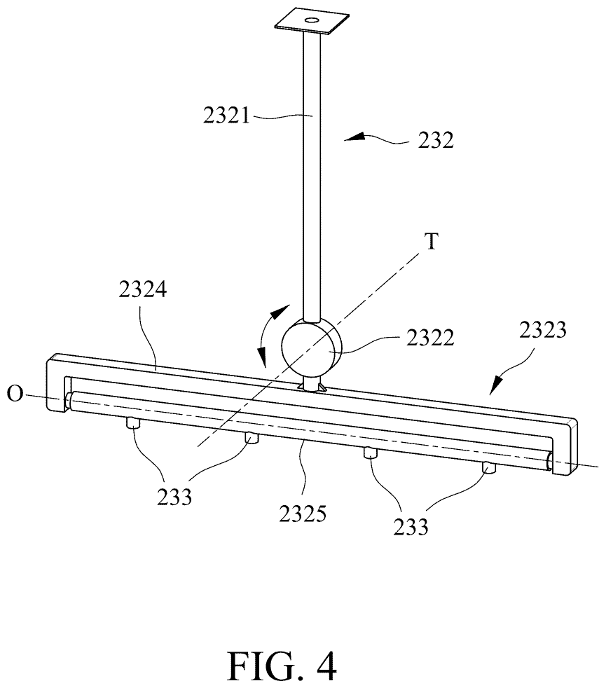

Further referring to FIG. 4, the cleaning module 23 includes a fluid storage tank 231 adapted for storing the cleaning liquid, a cleaning bracket 232 fixedly connected to and disposed under the machine body 21, and a plurality of nozzles 233 mounted to the cleaning bracket 232, in fluid communication with the fluid storage tank 231, and adapted for spraying the cleaning liquid. The cleaning liquid stored in the fluid storage tank 231 may be water or a detergent dedicated for cleaning the solar panels 93. It should be noted that in this embodiment, the fluid storage tank 231 is included in the cleaning module 23 but the present disclosure is not limited hereto. In other embodiments, the fluid storage tank 231 may be separate from the unmanned aerial vehicle 2, disposed at a position adjacent to the solar power equipment, and in fluid communication with the nozzles 233 such that the nozzles 233 may spray the cleaning liquid stored in the fluid storage tank 231. The cleaning bracket 232 includes a support rod 2321 fixedly connected to the machine body 21, a rotatable member 2322 connected to a distal end of the support rod 2321 that is away from the machine body 21, and rotatable about a tilt axis (T) extending horizontally, and a mounting seat 2323 connected to and co-rotatable with the rotatable member 2322. The nozzles 233 are mounted to the mounting seat 2323. The mounting seat 2323 includes a base portion 2324, and a rotary tube 2325 pivotably connected to the base portion 2324 and rotatable about an overturn axis (O) perpendicular to the tilt axis (T). In one embodiment, a length of the rotary tube 2325 is designed to conform with a width of each of the solar panels 93, and the nozzles 233 are mounted to the rotary tube 2325 and are spaced apart from each other, such that the nozzles 233 are adapted for spraying the cleaning liquid to cover a range of the length of the rotary tube 2325. It should be noted that, the number of the nozzles 233 may be designed to meet cleaning requirements and is not limited to what is depicted in the drawings.

In this embodiment, the storage module 25 is a hard disk. It should be noted that, in other embodiments, the storage module 25 may be: a machine or computer-readable storage medium of a memory such as random access memory (RAM), read only memory (ROM), programmable ROM (PROM), firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application specific integrated circuit (ASIC), complementary metal oxide semiconductor (CMOS), transistor-transistor logic (TTL) technology, etc.; or any combination thereof. The relevant data stored in the storage module 25 may include the at least one operation instruction, the movement route and the flight path information that are used in subsequent flights.

Referring back to FIGS. 1 and 2, the inertial measurement unit 3 is mounted to a center of gravity of the machine body 21 of the unmanned aerial vehicle 2, is communicatively connected to the operational processor 22, and is configured to detect a posture parameter set of the machine body 21 related to a movement of the machine body 21 and to output the posture parameter set to the operational processor 22. Specifically, the inertial measurement unit 3 is configured to detect roll information indicative of a movement of the machine body 21 relative to a roll axis of the unmanned aerial vehicle 2, pitch information indicative of a movement of the machine body 21 relative to a pitch axis of the unmanned aerial vehicle 2 that is perpendicular to the roll axis, and yaw information indicative of a movement of the machine body 21 relative to a yaw axis of the unmanned aerial vehicle 2 that is perpendicular to the roll axis and the pitch axis. The roll information, the pitch information and the yaw information are included in the posture parameter set. The inertial measurement unit 3 includes a magnetometer 31 configured to obtain the roll information, a gyroscope 32 configured to obtain the pitch information, and an accelerometer 33 configured to obtain the yaw information. In this way, the unmanned aerial vehicle 2 may be controlled by the operational processor 22 to fly smoothly along a certain flight path. It should be noted that, since the main feature of the present disclosure does not reside in how the operational processor 22 controls the unmanned aerial vehicle 2 based on the posture parameter set, further details of the same are not described for the sake of brevity.

The dynamic sensor unit 4 is communicatively connected to the operational processor 22, and is configured to detect a dynamic information set related to a position of the unmanned aerial vehicle 2 and to output the dynamic information set to the operational processor 22. The dynamic sensor unit 4 includes a satellite navigation module 41 that is configured to provide position information and altitude information of the machine body 21 to the operational processor 22, a real time kinematic (RTK) positioning module 42 that is configured to correct the position information of the machine body 21 upon receipt of the same and that is configured to provide accurate position information of the machine body 21 based on the position information, a radar 43 that is configured to detect an object around the unmanned aerial vehicle 2 and provide distance information indicating a distance between the unmanned aerial vehicle 2 and the object detected by the radar 43, thereby preventing the unmanned aerial vehicle from hitting the object, a pressure gauge 44 that is configured to provide pressure information which is an ambient atmospheric pressure around the unmanned aerial vehicle 2, and an anemoscope 45 that is configured to provide airflow information indicative of a direction of wind, i.e., direction from which wind originates, around the unmanned aerial vehicle 2. The position information, the altitude information, the accurate position information, the distance information, the pressure information, and the airflow information are included in the dynamic information set. The operational processor 22 is configured to receive the position information, the altitude information, the accurate position information, the pressure information, and the airflow information and to control the unmanned aerial vehicle 2 to fly stably based on the abovementioned information in real time. That is to say, in a case where the ambient atmospheric pressure or a direction of wind, i.e., direction from which wind originates, around the unmanned aerial vehicle 2 changes, the unmanned aerial vehicle 2 is controlled in real time by the operational processor 22 accordingly to maintain flight stability. In one embodiment, the radar 43 is a millimeter wave radar.

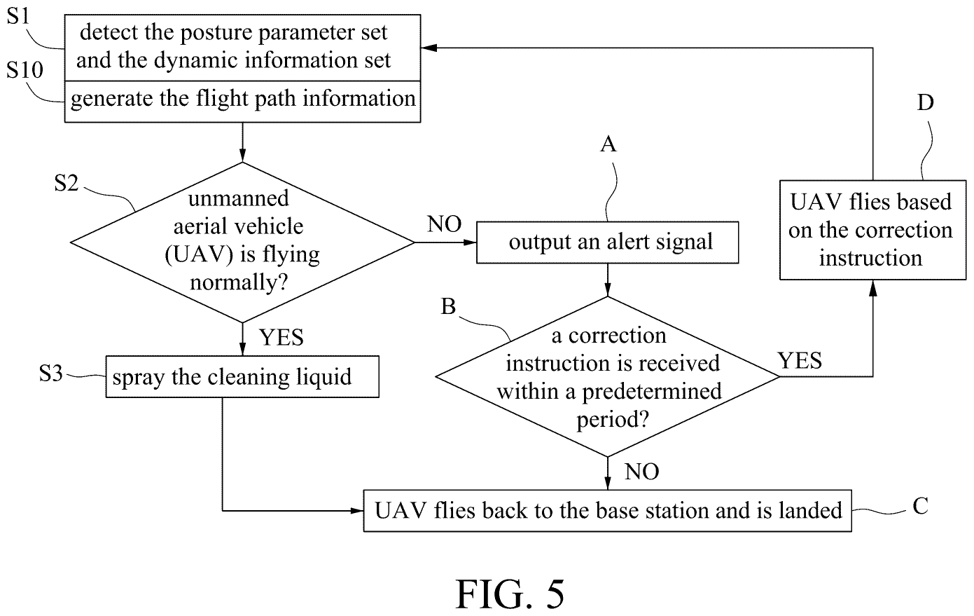

Referring to FIG. 5, a flow chart illustrating a cleaning process of the embodiment is shown. It should be noted that the following descriptions are merely examples and the present disclosure is not limited to the specific sequence describe herein. Generally, upon receipt of an operation instruction such as a departure instruction from the control console 1, the unmanned aerial vehicle 2 departs from a base station (not shown) and flies toward the solar power equipment. The unmanned aerial vehicle 2 continuously flies in a stable manner by virtue of the inertial measurement unit 3 and the dynamic sensor unit 4 that are communicatively connected to the operational processor 22. Specifically, in step S1, the inertial measurement unit 3 and the dynamic sensor unit 4 respectively detect the posture parameter set and the dynamic information set, and output the same to the operational processor 22. In step S2, the operational processor 22 continuously compares a plurality of operation instructions with the posture parameter set and the dynamic information set in real time to determine whether the unmanned aerial vehicle 2 is flying normally, i.e., flying based on the operation instructions. It should be noted that the plurality of operation instructions may be sequentially received from the control console 1 or stored in the storage module 25 in advance. When the operational processor 22 determines that the unmanned aerial vehicle 2 is flying normally, the unmanned aerial vehicle 2 hovers above the first support frames 91 and the second support frames 92 and awaits another operation instruction, e.g., a cleaning instruction, output from the control console 1 to start cleaning the solar panels 93. In step S3, upon receipt of the cleaning instruction by the operational processor 22, the cleaning module 23 sprays the cleaning liquid to clean the solar panels 93 as controlled by the operational processor 22. When the operational processor 22 determines that the unmanned aerial vehicle 2 is not flying normally, a flow of the cleaning process goes to step (A). In step (A), the unmanned aerial vehicle 2 outputs an alert signal and hovers above the first support frames 91 and the second support frames 92. Subsequent to step (A), in step (B), the operational processor 22 determines whether a correction instruction is received within a predetermined period. When the operational processor 22 does not receive a correction instruction after the predetermined period has elapsed, the flow goes to step (C), otherwise the flow goes to step (D). In step (C), the unmanned aerial vehicle 2 flies back to the base station and is landed. On the other hand, in a case where a correction instruction is received within the predetermined period, in step (D), the unmanned aerial vehicle 2 is controlled by the operational processor 22 to fly based on the correction instruction, and the flow goes back to step S1. It should be noted that step S1 may include a sub-step S10 performed by the route detection module 24. In sub-step S10, the image capture device 241 of the route detection module 24 captures a to-be-analyzed image around the machine body 21 relative to the solar power equipment, and the image processor 242 of the route detection module 24 generates the flight path information based on the to-be-analyzed image for assisting in movement of the machine body 21 along the movement route. In this way, in step S3, the unmanned aerial vehicle 2 may fly stably along the movement route and parallel to the first support frames 91 and the second support frames 92, and the cleaning module 23 may accurately spray the cleaning liquid on the solar panels 93 to clean the solar power equipment. After a certain criteria is satisfied, e.g., some of the solar panels 93 that are disposed within a designated area are cleaned, the flow of the cleaning process goes to step (C), in which the unmanned aerial vehicle 2 returns to the base station and is landed. It should be noted that each of the operational processor 22 and the image processor 242 is a microcontroller or a controller such as, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

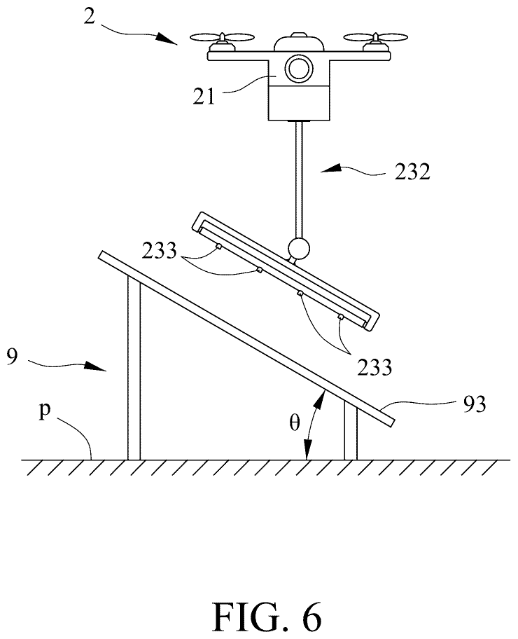

Referring to FIGS. 6 to 8, it should be noted that, in order to provide a relatively good cleaning effect, the cleaning bracket 232 of the cleaning module 23 may be adjusted based on various conditions such as arrangement of the solar panels 93 during the cleaning operation. Specifically, in a case where the solar panels 93 of the solar power equipment are inclined relative to a horizontal plane (P) at an inclination angle (θ) as depicted in FIG. 6, the rotatable member 2322 of the cleaning bracket 232 is driven by the operational processor 22 to rotate relative to the horizontal plane (P) according to the inclination angle (θ), and thus the mounting seat 2323 is inclined relative to the horizontal plane (P) at the inclination angle (θ). In this way, the rotary tube 2325 of the mounting seat 2323 is generally parallel to the solar panels 93 so that the nozzles 233 mounted to the rotary tube 2325 are generally equidistant from the solar panels 93 and spray the cleaning liquid thereon.

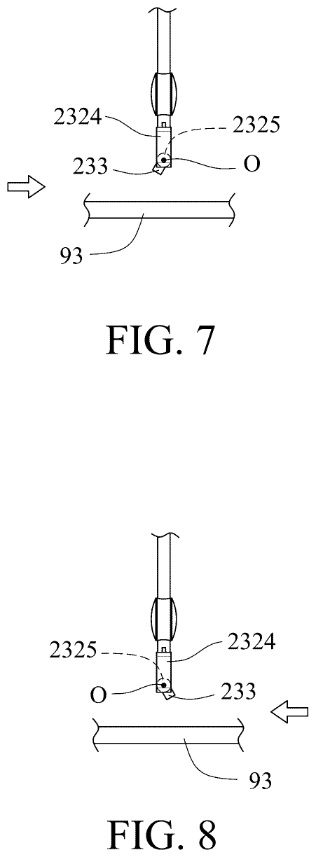

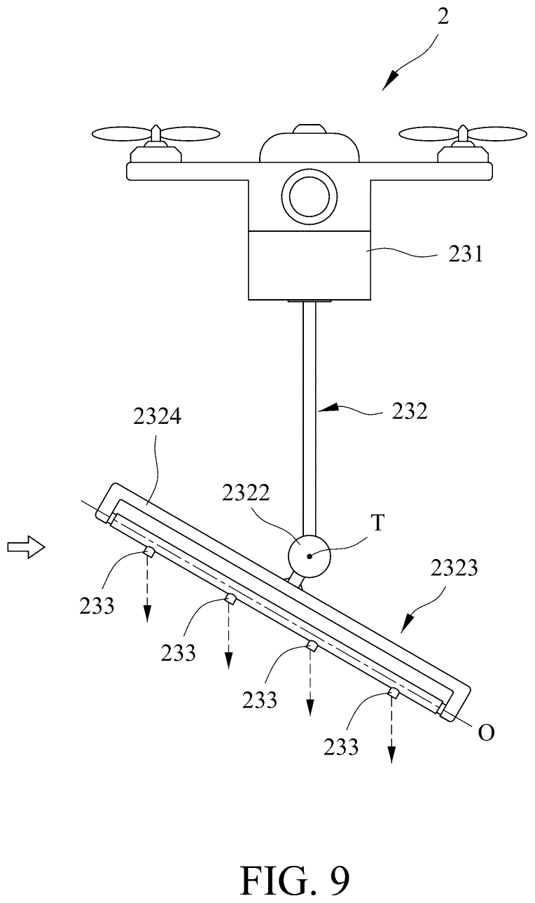

Referring to FIGS. 7 and 8, the rotary tube 2325 of the mounting seat 2323 are driven by the operational processor 22 to rotate relative to the base portion 2324. Specifically, two hollow arrows in FIGS. 7 and 8 respectively represent two opposite directions of wind flow around the unmanned aerial vehicle 2. The rotary tube 2325 is driven by the operational processor 22 to rotate about the overturn axis (O) based on the airflow information according to the airflow information provided by the anemoscope 45. In this embodiment, in a case where wind flows from the left to the right in FIG. 7, the rotary tube 2325 is rotated to the left to face the wind, i.e., the direction from which the wind is blowing. Similarly, the rotary tube 2325 is rotated to the right to face the wind in FIG. 8. Further referring to FIG. 9, the rotary tube 2325 is also driven by the operational processor 22 to rotate about the tilt axis (T) based on the airflow information. In this way, when a direction of wind around the unmanned aerial vehicle 2 changes, the airflow information provided by the dynamic sensor unit 4 is not only utilized for stabilizing flying of the unmanned aerial vehicle 2, but also used to change directions of the nozzles 233 mounted on the rotary tube 2325 to prevent the cleaning liquid from being blown away from the solar panels 93 by the wind. Thus, the nozzles 233 are capable of spraying the cleaning liquid accurately onto the solar panels 93 to clean the same.

To sum up, the embodiment of the cleaning system for the outdoor equipment 9 according to the present disclosure not only utilizes the inertial measurement unit 3 and the dynamic sensor unit 4 to stabilize flying of the unmanned aerial vehicle 2, but also introduces the flight path information generated by the route detection module 24 to ensure that the unmanned aerial vehicle 2 is flying in either one of the first direction (D1) or the second direction (D2), and thus meets the requirements for cleaning the outdoor equipment 9 in a relatively efficient and accurate manner.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A cleaning system for an outdoor equipment, the outdoor equipment including a plurality of first support frames that are spaced apart from each other in a first direction, a plurality of second support frames that are spaced apart from each other in a second direction transverse to the first direction and that intersect the first support frames to form a matrix, and a plurality of panels that are mounted on the first support frames and the second support frames, said cleaning system for the outdoor equipment comprising:
a control console that is operable to output at least one operation instruction;
at least one unmanned aerial vehicle that is communicatively connected to said control console, that is movable according to the at least one operation instruction upon receipt of the at least one operation instruction, and that includes
an operational processor configured to receive and process the at least one operation instruction to generate movement information,
a machine body connected to said operational processor, and communicatively connected to said operational processor for receiving the movement information, and being moved according to the movement information,
a cleaning module mounted to said machine body and adapted for spraying a cleaning liquid to clean the panels, and
a route detection module communicatively connected to said operational processor, and configured to detect a position of said machine body relative to the first support frames and the second support frames of the outdoor equipment to generate flight path information that is for assisting in movement of said machine body along a movement route; and
an inertial measurement unit that is mounted to a center of gravity of said machine body of said unmanned aerial vehicle, that is communicatively connected to said operational processor, and that is configured to detect a posture parameter set of said machine body related to a movement and posture of said machine body and to output the posture parameter set to said operational processor.

2. The cleaning system as claimed in claim 1, wherein:
said cleaning system further comprises a dynamic sensor unit mounted to said unmanned aerial vehicle;
said dynamic sensor unit is communicatively connected to said operational processor, and is configured to detect a dynamic information set related to a position of the unmanned aerial vehicle and to output the dynamic information set to said operational processor.

3. The cleaning system as claimed in claim 2, wherein:
said dynamic sensor unit includes a satellite navigation module that is configured to provide position information and altitude information of the machine body to said operational processor; and
the position information and the altitude information are included in the dynamic information set.

4. The cleaning system as claimed in claim 3, wherein:
said dynamic sensor unit further includes a real-time kinematic positioning module that is configured to correct the position information of said machine body upon receipt of the position information, and that is configured to provide accurate position information of the machine body based on the position information; and
the accurate position information is included in the dynamic information set.

5. The cleaning system as claimed in claim 3, wherein:
said dynamic sensor unit further includes a radar that is configured to detect an object around said unmanned aerial vehicle and provide distance information indicating a distance between said unmanned aerial vehicle and the object detected by said radar, thereby preventing said unmanned aerial vehicle from hitting the object; and
the distance information is included in the dynamic information set.

6. The cleaning system as claimed in claim 3, wherein:
said dynamic sensor unit further includes a pressure gauge that is configured to provide pressure information which is an ambient atmospheric pressure around said unmanned aerial vehicle; and
the pressure information is included in the dynamic information set.

7. The cleaning system as claimed in claim 3, wherein:
said dynamic sensor unit further includes an anemoscope that is configured to provide airflow information indicative of a direction of wind around said unmanned aerial vehicle; and
the airflow information is included in the dynamic information set.

8. The cleaning system as claimed in claim 7, wherein:
said cleaning module of said unmanned aerial vehicle includes a cleaning bracket fixedly connected to and disposed under said machine body, and
a plurality of nozzles mounted to said cleaning bracket, adapted to be in fluid communication with a fluid storage tank storing the cleaning liquid, and adapted for spraying the cleaning liquid.

9. The cleaning system as claimed in claim 8, wherein said cleaning bracket includes:
a support rod fixedly connected to said machine body,
a rotatable member connected to a distal end of said support rod that is away from said machine body and rotatable about a tilt axis extending horizontally, and
a mounting seat connected to and co-rotatable with said rotatable member, said nozzles being mounted to said mounting seat.

10. The cleaning system as claimed in claim 9, the panels of the outdoor equipment being inclined relative to a horizontal plane at an inclination angle, wherein said rotatable member of said cleaning bracket is driven by said operational processor to rotate relative to the horizontal plane according to the inclination angle and thus said mounting seat being inclined relative to the horizontal plane at the inclination angle.

11. The cleaning system as claimed in claim 9, wherein:
said mounting seat of said cleaning bracket includes
a base portion, and
a rotary tube pivotably connected to said base portion and rotatable about an overturn axis perpendicular to the tilt axis; and
said nozzles are mounted to said rotary tube and are spaced apart from each other.

12. The cleaning system as claimed in claim 11, wherein said rotary tube of said mounting seat of said cleaning bracket is driven by said operational processor to rotate about the overturn axis based on the airflow information.

13. The cleaning system as claimed in claim 11, wherein said rotatable member of said cleaning bracket is driven by said operational processor to rotate about the tilt axis based on the airflow information.

14. The cleaning system as claimed in claim 1, wherein:
said route detection module of said unmanned aerial vehicle includes
an image capture device configured to capture a to-be-analyzed image around said machine body for detecting the position of said machine body relative to the first support frames and the second support frames when said unmanned aerial vehicle is flying, and
an image processor communicatively connected to said image capture device and configured to generate, based on the to-be-analyzed image, the flight path information that is indicative of directions in which said unmanned aerial vehicle is controlled to fly.

15. The cleaning system as claimed in claim 1, wherein said unmanned aerial vehicle further includes a storage module communicatively connected to said operational processor and configured to store the at least one operation instruction received by said operational processor, the movement route and the flight path information each time said cleaning system cleaning the outdoor equipment.

16. The cleaning system as claimed in claim 1, wherein:
said inertial measurement unit is configured to detect roll information indicative of a movement of the machine body relative to a roll axis of said unmanned aerial vehicle, pitch information indicative of a movement of the machine body relative to a pitch axis of said unmanned aerial vehicle that is perpendicular to the roll axis, and yaw information indicative of a movement of the machine body relative to a yaw axis of said unmanned aerial vehicle that is perpendicular to the roll axis and the pitch axis;
the roll information, the pitch information and the yaw information are included in the posture parameter set; and
said inertial measurement unit includes
a magnetometer configured to obtain the roll information,
a gyroscope configured to obtain the pitch information, and
an accelerometer configured to obtain the yaw information.
